(19) United States
(12) Patent Application Publication
(10) Pub. No.: US 2005/0174678 A1
(43) Pub. Date: Aug. 11, 2005

(54) Stepping power consumption levels in a hard disk drive to maximize performance while minimizing power consumption

(75) Inventors: Fernando A. Zayas, Loveland, CO (US); Richard M. Ehrlich, Saratoga, CA (US); Thorsten Schmidt, Milpitas, CA (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd, Kadoma-shi (JP)

(21) Appl. No.: 11/021,659

(22) Filed: Dec. 22, 2004

Related U.S. Application Data
(60) Provisional application No. 60/532,410, filed on Dec. 24, 2003.

(51) Int. Cl. G11B 15/46

(52) U.S. Cl. 360/73.03

(57) ABSTRACT

Attributes of a hard disk drive are stepped between different power consumption levels to optimize the trade-off between minimizing power consumption and maximizing performance depending on whether AC or battery power is used. One attribute is the clock speed which can be changed for a number of disk drive components including the processor, the external interface bus and the memory interface bus. The system power supply voltage can further be changed in a number of components integrated together on an application specific integrated circuit (ASIC). Further, spindle motor rotation speed can be changed, or the spindle motor spun-down. Further, actuator movement by the VCM can be controlled to provide faster movement during track seek operations when high performance is desired. Additionally, write-back caching parameters are adjusted based on the source of power for the hard drive, be it battery, AC power, or a combination.

### PRIOITY CLAIM TO PROVISIONAL APPLICATION

This Patent Application claims priority to U.S. Provisional Patent Application No. 60/532,410, entitled “Apparatus For Stepping Power Consumption Through Multiple Levels To Optimize The Tradeoff Between Maximizing Performance And Minimizing Power Consumption,” filed Dec. 24, 2003 (Attorney Doc. No. PANAP-01004US3), which is incorporated by reference in its entirety.

### BACKGROUND

1. Technical Field

The present invention relates to the configuration of components of hard disk drives so that power consumption levels can be altered to minimize power consumption when desirable, such as when battery power is used, while performance is maximized when power consumption is of less concern.

2. Related Art

A hard disk drive assembly is a mass-storage device from which data may be read and/or written. Typically the hard disk drive includes one or more randomly accessible rotatable storage media, or disks upon which data is encoded. The disks are rotated using a spindle motor which typically turns at a constant operation speed. In a magnetic disk drive, the data is encoded as bits of information using magnetic field reversals grouped in tracks on the magnetic hard surface of the rotating disks. Transducer heads supported by an actuator arm are used to read data from or write data to the disks. The transducer heads include sliders which effectively fly above the disks using air currents generated by the disk rotation. A voice control motor (VCM) attached to the actuator controls positioning of the actuator, and thus the position of the transducer heads over a disks. When the disk drive spindle motor is turned off, or spun down, the transducer heads are parked on a ramp off of the disks by the actuator to prevent the heads from contacting the disk surface.

Servo data, along with other data read from or written to the disk is provided through a read/write channel to a disk hard controller. The hard disk controller provides data to and from components including an external interface bus, an on board random access memory (RAM), and a processor. Servo position data read from the disk is processed by the processor, enabling the processor to provide servo current commands to control the VCM for proper positioning of a transducer heads relative to a disk. The processor further provides control to the spindle motor to control spin-up and spindle motor operation speed.

When a hard drive system is intended to be mobile, and the enclosing system includes an internal battery, the system is typically set to operate at a low power level. With low power, overall performance is typically sacrificed in return for maximizing battery life. Some features, however, may be set to consume additional power when maximizing performance is more desirable than maximizing battery life. For non-portable hard disk drives which operate indirectly using AC and do not require batteries, system power levels are not as significant an issue and the system power levels are more typically set at a high level to maximize performance.

Other considerations than reduced battery power consumption may dictate changing system attributes to optimize a tradeoff between minimizing power consumption and maximizing performance. For instance, it may be desirable to spin down the spindle motor when the disk drive is not accessed for a period of time to increase the operation life of the spindle motor. Steps may be taken to minimize power consumption of other disk drive components to increase their operation life. Further, write-back caching may defer writing to the media for a longer period of time to help reduce power. Power consumption is reduced by bringing up the mechanical components less often that tend to bum power.

Apart from attributes such as spinning down the spindle motor, or increasing the residency time of write-back caching to minimize power consumption, a number of other methods are available to minimize power consumption, depending on performance vs. power tradeoffs. Two other methods to reduce power consumption include reducing the core clock frequency of components and reducing system voltage levels for components of the disk drive. Power varies approximately linearly with clock speed and by the square of voltage as evidenced by the following equation:
Power=(Total Capacitance×Frequency×Voltage²)/2
The operation frequency, and thus power consumption can be linearly adjusted by reducing the clock rate. Adjusting both clock rate and system voltage level can produce approximately cubic reductions in power consumption.

It is desirable to have a disk drive system which can automatically minimize power consumption when desired, such as when battery power is used, and then increase performance when power consumption is less critical, such as when power is switched from batteries to an AC outlet. It is further desirable to have components which can be set by a user to adjust power consumption to optimize the tradeoff between minimizing power consumption and maximizing performance.

### SUMMARY

In accordance with the present invention, features of a disk drive are modified during operation to optimize the trade-off between minimizing power consumption and maximizing performance.

In one embodiment, an indication is provided to the disk drive from the system power supply indicating when system power is provided from an AC outlet, or from a battery. One or more disk drive features are then set to maximize performance when the power supply indicates AC power is used, but then when the power supply indicates battery power is used the features are reset at a lower performance level to minimize power consumption. Write-back caching residency time can be increased when battery power is utilized, but with AC power write-back caching residency time is reduced to provide higher data integrity.

Features which may be set to maximize the tradeoff between performance and power consumption include changing the motor speed for the spindle motor and the VCM. The spindle motor rotation speed can be changed depending on power consumption desired. In one embodiment, the spindle motor is spun down completely when the disk drive has not been accessed for a period of time, and spun up again when later accessed to conserve power if low power consumption is desired. Actuator movement by the VCM can be controlled to provide faster movement during track seek operations when high performance is desired, but then to provide slower actuator movement during track seek when minimum power consumption is desirable.

Other features likewise can be changed to maximize the tradeoff between performance and power consumption including altering clock speed to components to obtain a linear power savings, and/or changing system voltage provided to components to obtain an exponential change in power savings, as described previously. Clock speed can be changed for a number of disk drive components including the processor, the external interface bus, the memory interface bus connected to the cache memory as well as the memory interface bus between the SRAM and the processor. The system power supply voltage can further be changed for individual components or for a number of components integrated together on an application specific integrated circuit (ASIC).

In a further embodiment of the present invention, power levels are stepped between two or more power settings depending on performance vs. power consumption tradeoffs (either automatically or as set by a user). As an example the spindle motor speed is maximized when AC power is used, then reduced to a lower speed when battery power is used or as set by the user, and finally spun down completely when a lower power mode is entered to increase the life expectancy of the spindle motor (with provisions to prevent spin down and spin up from occurring too frequently). Further, processor clock speed can be maximized when AC power is used, then reduced to a low speed when battery power is used, but increased to an intermediate level when read or write command occurs, or to a slightly higher level when more critical code is processed, such as a servo interrupt. At a lower spin speed, the data rate to and from the disk is reduced, lowering the frequency of switching within the read channel and thus lowering power. At lower spin speed and lower clock rates, the operating core voltage of the ASIC is reduced further reducing power.

### BRIEF DESCRIPTION OF THE DRAWINGS

Further details of the present invention are explained with the help of the attached drawings in which:

FIG. 1 shows a block diagram of components of a system with a hard disk drive configured to enable optimizing the tradeoff between power consumption and performance in accordance with the present invention;

FIG. 2 illustrates the subdivision of tracks on a hard disk into servo and data sectors;

FIG. 3A shows further details of one embodiment of the power supply controller where the power supply controller effectively provides a switching Uninterruped Power Supply (UPS);

FIG. 3B shows a second embodiment of the power supply controller where the power supply controller effectively provides a continuous UPS;

FIG. 4 shows further details of the power management controller of FIG. 1;

FIG. 5 shows further details of the clock controller of FIG. 1;

FIG. 6 shows further details of the spindle motor and spindle motor driver of FIG. 1; and

FIG. 7 shows further details of the VCM driver and VCM of FIG. 1.

### DETAILED DESCRIPTION

### I. System Overview

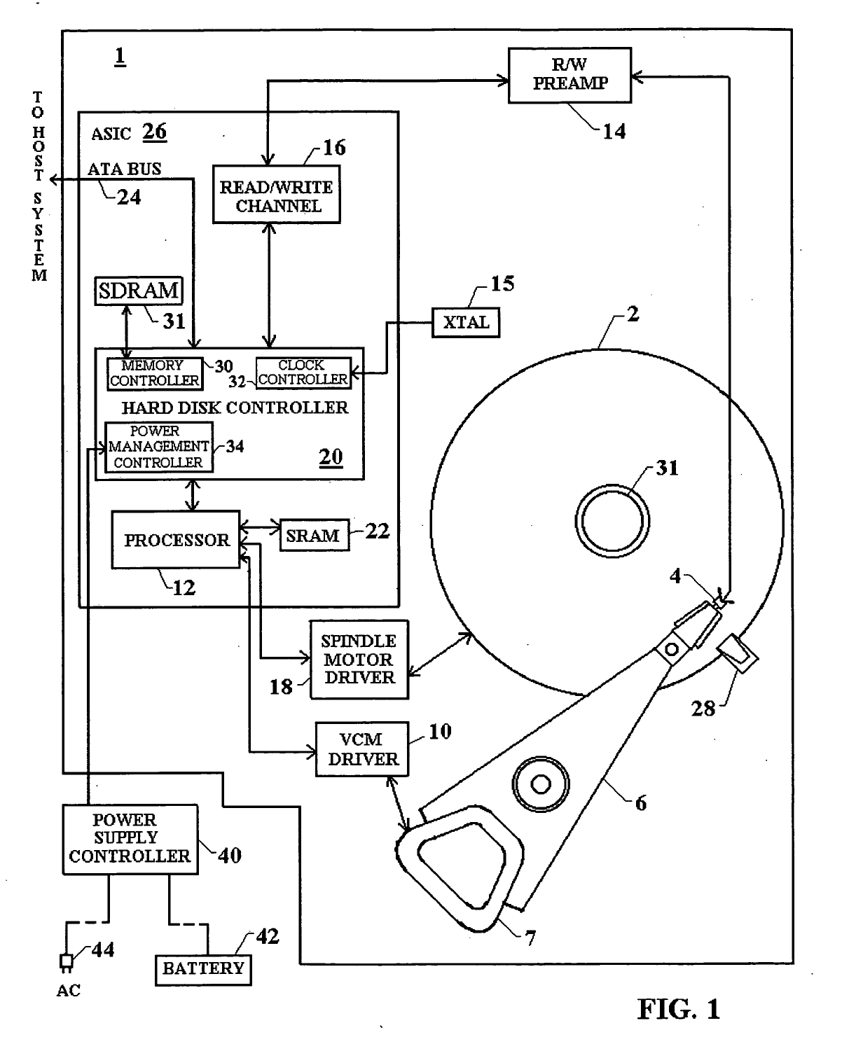

FIG. 1 shows a block diagram of components of a system with a hard disk drive 1 configured to enable optimizing the tradeoff between power consumption and performance in accordance with the present invention. The hard disk drive 1 includes a rotating disk 2 containing a magnetic medium for storing data in defined tracks. Data is written to or read from the storage medium using a transducer or read/write head 4 provided on an actuator 6. The actuator movement is controlled by a voice control motor (VCM) 7 made up of a magnet and a coil configured for receiving an external control signal.

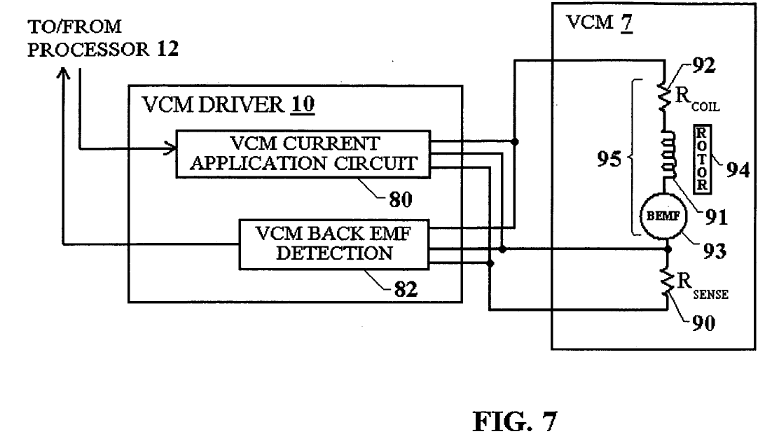

Current is provided to the coil of the VCM 7 to control the position of the actuator using a VCM driver 10. The VCM driver 10 in turn receives current command signals from a processor 12, enabling the VCM driver 10 to apply an amount of current to the coil of the VCM 7 to position the actuator 6 over a desired track of the rotating disk 2. More details of the VCM driver are described subsequently with respect to FIG. 7.

The disk 2 contains multiple tracks where data is stored. The data is read from or written to the rotating disk 2 using the transducer head 4. The analog data read is provided through a read/write (R/W) pre-amplifier 14. The amplified read data is provided to the R/W channel 16, which includes circuitry to convert the data from analog to digital and decode the digital data to provide to the hard disk controller (HDC) 20. The R/W channel 16 further converts data received from the HDC 20 to be written from digital to analog for providing through the R/W preamp 14 to transducer head 4. The data read includes servo data provided in digital form from the HDC 20 to the processor 12.

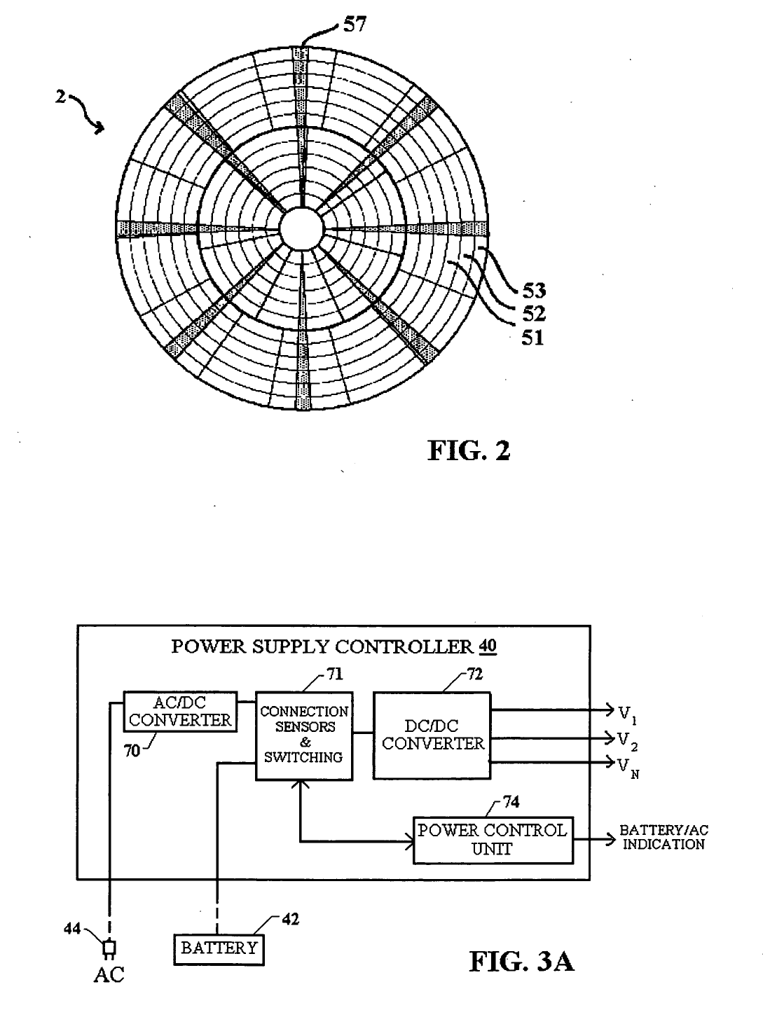

Servo data provided to the processor 12 includes information indicating track positioning of the transducer head 4 over the rotating disk 2. The track positioning information indicates the track the transducer head 4 is placed over, as well as any misalignment of the transducer head 4 relative to a track. Servo data is recorded periodically along each track on the rotating disk 4 between other non-servo data as illustrated in FIG. 2. FIG. 2 shows a number of data tracks 51-53 on a rotating disk 2, with the tracks being subdivided. Servo sectors, such as sector 57, are provided where servo data is written on a track. The placement of servo sectors, such as 57, between data sectors in the data tracks 51-53 illustrates that while the servo sample-rate generally stays the same across the stroke of the drive, there are usually more data-sectors at the outer diameter (OD) due to its increased circumference, relative to that at the inner diameter ID. The processor 12 determines track misalignment and computes a current command which is sent to the VCM driver 10 to correct for the track misalignment.

Also, if it is desired to read data from or write data to other tracks on the rotating disk 4, the processor 12 executes code which generates a target position consistent with the track where the desired read or write data is stored and sends a request to the actuator to move from the current position to the new target position. The request to move the head from one location to another is typically called a track seek operation.

The processor 12 further provides control commands to a spindle motor driver 18 to control the operation speed of the spindle motor. The spindle motor driver 18 in turn provides currents to the windings of the spindle motor to cause the desired motor speed. The spindle motor turns the rotatable disk 2, the spindle motor shaft 31 being shown in FIG. 1. While the spindle motor is at operation speed, a slider forming part of the transducer flies above the surface of the disk 2. When the spindle motor is spun down, the actuator 6 is moved up the ramp 28 beside the disk 2 so that the transducer head 4 does not contact the surface of the disk 2. Components of the spindle motor and spindle motor driver 18 are described in more detail subsequently with respect to FIG. 6.

Processor 12 executes instructions acquired from a stored control program to control disk drive functions. During startup, the control program is embedded in flash memory, or other non-volatile memory and then either executed directly, or loaded into a static random access memory (SRAM) 22 connected to the processor 12 or dynamic RAM (SDRAM) 31 connected to the HDC 20 and executed. Various firmware routines control operation of the actuator 6 and the spindle motor. Here, control programs include the instructions the processor 12 executes, and tables, parameters or arguments used during the execution of these programs.

The processor 12 also communicates through the HDC 20 to components external to the hard disk drive system through an advanced technology attachment (ATA) interface bus 24. As illustrated the ATA bus 24 can be connected to a host system operating the disk drive. The ATA bus 24 is also referred to as an integrated drive electronics (IDE) bus, and although specifically shown as an ATA bus, may be another type of external component interface, such as an SCSI or network interface, in accordance with the present invention.

The HDC 20 further provides access to additional memory 31, shown here as synchronous dynamic random access memory (SDRAM). The SDRAM is a type of DRAM that is synchronized with the bus connecting it to the memory controller 30. Note that although the memory controller 30 is shown as separate from the processor 12, the processor 12 could provide the function alone and be linked through memory controller 30 to the SDRAM 31.

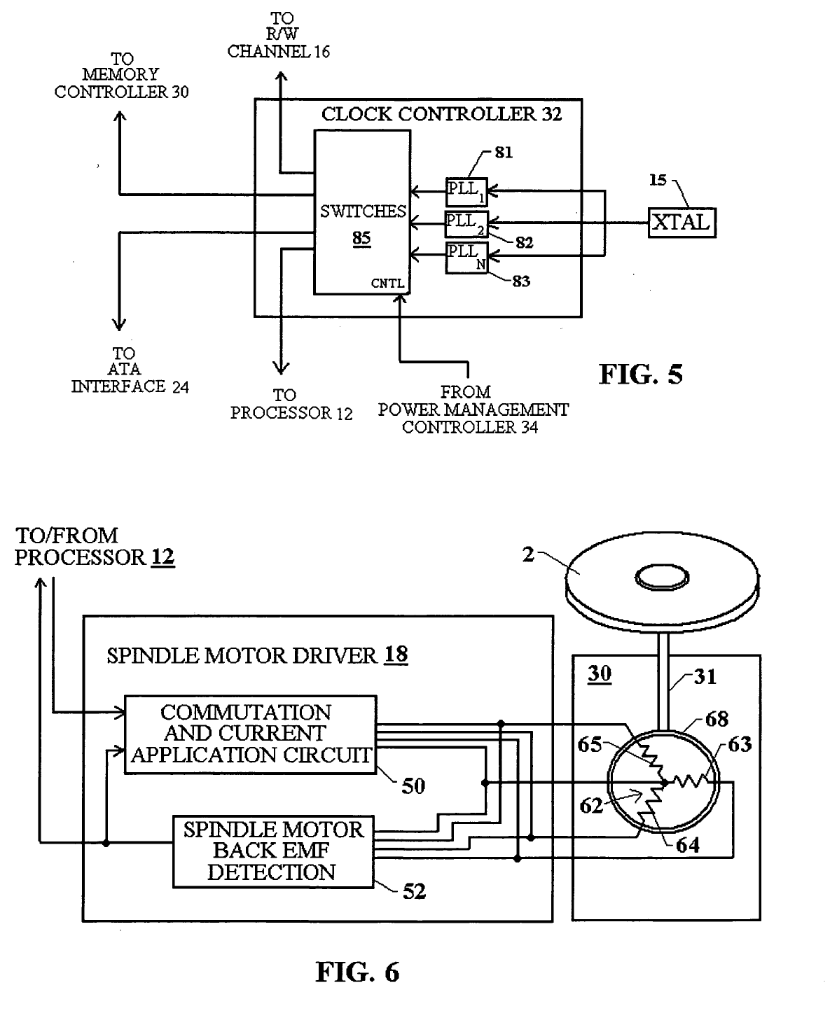

The HDC further includes a clock controller 32 for receiving a clock signal from a crystal 15 external to the ASIC. The clock controller 32 provides clocking signals to clock both the ATA interface bus and the memory controller bus, depending on the desired clock rate. The clock controller 32 also provides a clock signal to the processor 12 and read/write channel 16. More details of the clock controller 32 are described with respect to FIG. 5.

For a hard disk drive, application specific integration circuits (ASICs) have been created to integrate a number of circuit components onto a single chip. One such ASIC 26 is illustrated in FIG. 1. As shown, the ASIC 26 integrates the processor 12, SRAM 22, R/W channel 16, HDC 30, SDRAM 26, and ATA interface bus 24 all onto a single chip. The chip for disk drive control is often referred to as a system on a chip (SOC). Although components such as the VCM driver 18 and spindle motor driver 10 are shown to be separate from the ASIC 26, it is understood that the present invention contemplates that the components may similarly be integrated with other components of the ASIC 26. Further, although a single processor 12 is shown, it is understood that the functions of processor 12 can be divided among multiple processors when desirable.

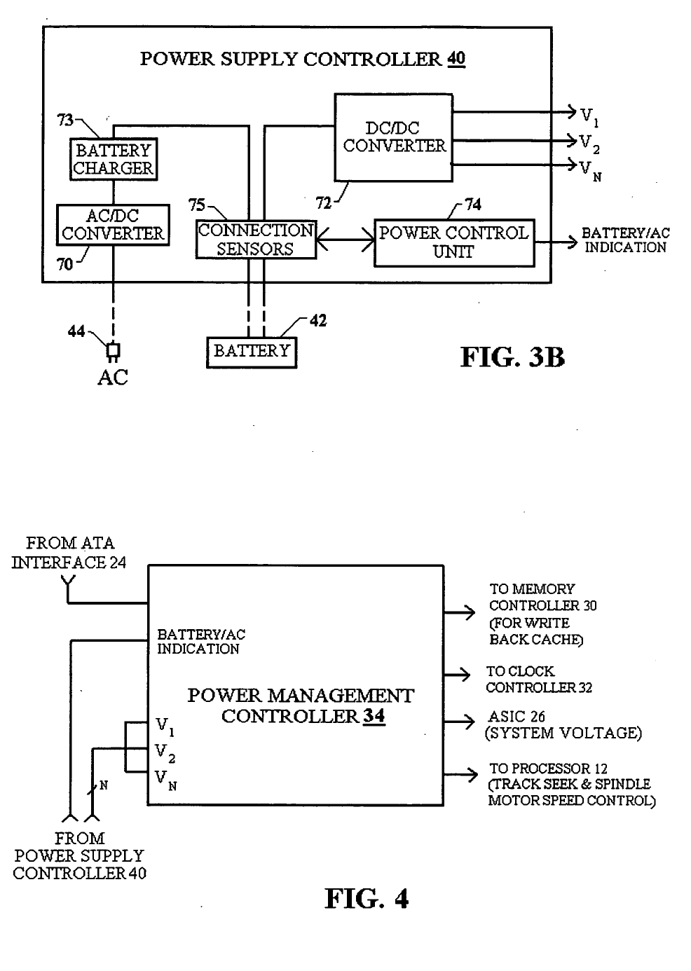

Provided external to the hard disk drive 1 in the system of FIG. 1 is a power supply controller 40. The power supply controller 40 receives power from two possible connections, one for connecting to a battery 42 and another for connecting to an AC wall outlet 44. The power supply controller 40 internally includes circuitry to supply a number of voltages to the hard disk drive for operation, either converted from AC power 44 or provided from the battery 42. To enable maximizing battery life, a signal indicating if battery power or AC power is used can be provided from the power supply controller 40 to the hard disk drive 1 to enable power conservation techniques to be internally implemented by the disk drive. Similarly, the signal indicating if battery power or AC power is used can be provided in a message transmitted over the ATA bus enabling power control to be implemented externally. Details different embodiments of the power supply controller 40 are described subsequently with respect to FIGS. 3A-3B.

The power supply voltages and battery/AC power use indication signal from power supply controller 40 are provided to a power management controller 34 of the HDC 20. The power management controller 34 then functions to distribute system power, as well as to control components of the hard disk drive 1 to maximize the tradeoff between performance and power consumption. Details of the power management controller 34 are described subsequently with respect to FIG. 4. In one embodiment with the power management controller 34, the user dictates to the hard drive how the tradeoff is to take place. In yet another embodiment, the enclosing system takes input from the power supply controller 34 and dictates to the hard drive how the tradeoff is to take place.

A. Power Supply Controller

FIGS. 3A-3B show two embodiments illustrating details of the power supply controller 40 of FIG. 1. Both embodiments shown in FIGS. 3A-3B effectively provide an uninterrupted power supply (UPS). By “effectively” it is understood that some devices such as a laptop may not have a UPS, but when the laptop is plugged into AC power the same effective function occurs. A UPS generally protects a computer system against voltage surges, or a total power failure. The UPS can be one of two common types, a standby UPS, as illustrated by FIG. 3A, or a continuous UPS, as illustrated in FIG. 3B. A standby UPS runs a computer off of AC power until it detects a problem, such as AC power being disconnected. At that point, it very quickly (in five milliseconds or less) switches to battery supply. With the standby UPS the short time delay is provided in the power output when switching occurs between AC and battery. In a continuous UPS the computer is always running off of battery power and the battery is continuously being recharged. The battery charger continuously produces DC power. If the power fails, the battery then provides system power. There is no switch-over time in a continuous UPS. The standby UPS systems are more commonly used in personal computers since their cost is about half as much as that of a continuous system. The continuous systems are more typically used for servers and other more critical applications.

To enable power conservation techniques to be implemented in the system of the present invention, a (BATTERY/AC USE INDICATION) signal is provided from a power control unit 74 to system components. The battery/AC indication signal indicates if system power is supplied from batteries, or from an AC outlet when a standby UPS is used. With a continuous UPS, the battery AC use indication signal indicates if the AC outlet is connected. The battery/AC indication can also provide an indication of the amount of charge on the battery.

Common features in FIGS. 3A and 3B are shown with similar reference numbers. Common features include an AC connection outlet 44 and a battery connection 42. An AC/DC converter 70 converts AC power from a connected AC source to provide DC. Power provided from the AC/DC converter 70 or battery connection 42 is then supplied to a DC/DC converter 72. The DC/DC converter then divides the voltage from either the AC/DC converter 70 or battery connection 42 to provide a number of different system voltage levels V₁, V₂ . . . V_{N}. The power control unit 74 provides an indication if power is being provided from a battery 42 or if power is provided from an AC connection 44.

With the standby UPS as shown in FIG. 3A, with both AC and battery power connected, the power control unit 74 will sense power connection from the AC connection 44 using connection sensors and switching unit 71 and control switching to direct power to be supplied to the DC/DC converter from the AD/DC converter 70 using unit 71. The power control unit 74 may then direct separate charging of the battery from the AC connection by controlling circuitry not shown in FIG. 3A. Should the AC power be disconnected with the battery still connected, the power control unit 74 will sense the disconnection and switch voltage to be supplied from the battery to the DC/DC converter 72 with its connection to unit 71.

With the continuous UPS as shown in FIG. 3B power will be provided to the DC/DC converter 72 continually from the battery whether AC power is connected or not. The output of AC/DC converter 70 output will then be used only to charge the battery through battery charger 73. The power control unit 74 will sense connection of either or both of the battery and AC using connection sensors 75 and provide an output signal indicating battery or AC connection to enable external system components (such as a disk drive) to implement power saving techniques if battery power is used. Should both the AC and battery power be disconnected, the power control unit 74 sense the situation using sensors 75 and will generate an interrupt signal to provide externally to enable system components to be safely shut down.

### B. Power Management Controller

FIG. 4 shows further details of the power management controller 34 of the disk drive system 1 of FIG. 1. As shown, the power management controller 34 receives the battery/AC indication signal from the power supply controller 40, along with the system voltages V₁, V₂ . . . V_{N}. The power management controller can further receive a user input from the ATA interface bus 24. Alternatively, the battery/AC indication can be carried as a message over the ATA interface instead of having a dedicated signal. The ATA interface bus 24 provides a user input path to enable a user to selectively set performance levels of different components depending on power conservation and performance goals. The ATA interface bus 24 can further provide a source of commands that are made to the disk drive which when received enable the power management controller to increase or decrease performance levels for particular functions if desired. The ATA-bus might be the only source of information indicating battery or AC power use (i.e., the “battery/AC indication” may not be a separate wire, but could be a signal that is also communicated over the ATA bus). Based on these inputs, the power management controller 34 provides output signals to components to manage power consumption and performance levels, as described in more detail to follow.

1. Memory Controller

A signal is provided from the power management controller 34 to the memory controller 30 to control how often write-back caching is performed. Generally, caching is effective because most programs access the same data over and over. The most recently accessed data from the disk is stored in a cache memory buffer. When a user needs to access data from the disk, the disk processor first checks the disk cache to see if the data is there. Disk caching can dramatically improve performance because accessing a byte of data in RAM can be thousands of times faster than accessing a byte on a hard disk. By keeping as much of this information as possible in RAM, the computer avoids accessing the slower disk memory.

Write-back caching is a caching method in which modifications to data for storing on the media are not committed to the media until some time after the data has been received by the hard drive. In contrast, a write-through cache performs all write operations in parallel—data is written to the disk and to the cache simultaneously. Write-back caching can yield a better performance than write-through caching because it reduces the number of write operations to slow memory. With the performance improvement comes a slight risk that data may be lost if the system looses power, or otherwise crashes.

In accordance with the present invention, write-back caching is controlled by the state of the battery, the AC power, and/or the user's inputs. When battery only is powering the hard drive, write-back caching is used with a long residency time, and a shorter idle time before writing to the media. In this mode, performance is maximized but the mechanical components are brought up during idle periods to write the cached data to the media. When battery alone is powering the hard drive, write back caching is used with a long residency time and a longer idle time before writing to the media. In this mode, power is minimized because the mechanical components are used least frequently. When AC alone is power the hard drive, write back caching is still used but with a short residency time. This minimizes the risk of data loss. The user can override this behavior.

Further, with battery power used and AC power disconnected, battery power levels can be monitored, and the write-back caching performed based on battery level. In one embodiment, the residency and idle times are a function of remaining battery power.

2. Clock Controller

A signal is supplied from the power management controller 34 to the clock controller 32 to set the clock speed of different components. As noted previously, a reduction in clock speed will result in a corresponding linear reduction in power consumption. Alternatively increasing clock speed will increase performance. Clock speed is, thus, set depending on the desired tradeoff between performance and minimizing power consumption. Also note that by simply spinning slower, the data rate to/from the media is reduced thus reducing the frequency of operation of the read channel. Likewise, spinning faster will case the data rate to/from the media to increase thus increasing the frequency of operation of the read channel.

FIG. 5 shows details of the clock controller 32 of FIG. 1. As shown, the clock controller 32 includes a number of phase locked loops (PLLs) 81-83 which are connected to the external crystal 15. Although a crystal is shown, other types of oscillators may be used. The PLLs convert the frequency from the oscillator to the desired frequencies for individual components on the ASIC. For the illustration of FIG. 5, three such PLLs 81-83 are shown. The clock controller 32 further includes a multiplexer, or series of switches 85 controlled to select one of the PLL outputs to provide to selected components depending on the power vs. performance tradeoff.

Clock signals are directed from the switches 85 to selectively provide different clock signals to the processor 12, ATA interface 24, memory controller 30, and the R/W channel 16. At least two different clock signals can be selected for each component. For instance, the ATA interface 24 can be provided with a 133 MHz clock when high performance is desired and battery power consumption is not as critical, while a 66 MHz clock is provided when minimizing power consumption is more desirable. Similarly, the clock speed of the bus connecting the memory controller 30 and SDRAM memory 31 can be set higher when performance is desirable, and reduced when minimizing power consumption is desired. Also, a higher frequency clock signal can provided to the processor 12 when high performance is desired over power consumption. The clock signal provided to the R/W channel 16 is set based on the spindle motor spin speed which can be altered depending on the desired tradeoff between performance and power consumption.

As an alternative to PLLs 81-83 and switches 85, a single PLL can be included to provide a clock signal to each component, such as processor 12 or ATA interface 24, with internal dividers to generate the desired frequency in each component. Multiple PLLs for each desired frequency, as shown in FIG. 5 may, however, be desirable because of the added flexibility in generated frequencies.

In one embodiment, the clock signal frequency of components, such as the processor 12, are varied so that when AC power is used a high clock frequency is used, and when AC power is removed leaving only battery power for operation, the clock frequency is reduced to minimize power consumption.

In another embodiment, the clock signal frequency of components is varied depending on an operation being performed. For instance, in one embodiment, the performance critical code where clock speed is maximized is code starting from initial receipt of a servo interrupt until code is executed by the processor 12 causing a resulting current command signal to be sent to the VCM driver 10. The increased power consumption of the processor 12 from the start of the interrupt to the sending of the current command is considered desirable because it reduces phase loss due to control delays, improving overall servo performance.

In another embodiment, the processor speed is maximized when performance critical code is executed that is, in time, between the receipt of a read or write command through the host interface, such as the ATA interface, to code that is executed to cause a seek request to be sent. One aspect of the disk drive performance is to reduce the time between the receipt of the read or write command and the completion of such a command. The time from the receipt of the command and the start of the seek is a critical component of this overall time and thus performance. Consequently, increasing the processor clock frequency during the execution of this code can provide a significant increase in disk drive performance.

Depending on disk drive system requirements, it may be considered essential to process code other than code between the start of a servo interrupt and the sending of the current command or code between the receipt of a read or write command and the start of the seek at a fast clock speed without concern for power consumption. It may also be desirable to use intermediate clock speeds for some processing requirements. For instance, the system in accordance with the present invention contemplates use of a very low clock speed for a sleep mode when the drive is basically inoperative. In accordance with the present invention, it is contemplated that clock signals with faster speeds be provided to the processor during processing of some code when design considerations dictate that speed is preferable over processor power consumption. Code executing on the processor can select one of the desired clock signals depending on the operation being performed. Code stored in the SRAM 22, or other memory if present, selects different clock signals as desired.

3. ASIC System Voltage

The power management controller 34 further sets the ASIC system voltage system voltage using one of the voltages V₁, V₂, . . . V_{N} depending on the tradeoff between performance and power consumption. As indicated previously, reducing the system voltage of components can generate an exponential savings in power consumption if performance is not critical. In accordance with the present invention, the ASIC system voltage change can be changed for one or more of the components on the ASIC 26, such as the processor 12, HDC 20, or read channel 16. The system voltage can be altered depending on the connection of AC power or the use of battery power alone and/or during different operations performed by the disk drive.

4. Processor Operations

a. Spindle Speed

Signals are further provided from the power management controller 34 to the processor 12 to control speed of the spindle motor. The processor 12 is shown in FIG. 1 providing signals to control spindle motor driver 18. In disk drives of mobile devices, spindle motor spin speed is on the order of 5400 RPM, while in stationary drives spin speed is increased to be on the order of 7200 RPM because maximizing performance is a greater concern for the stationary devices which do not use battery power. In accordance with the present invention, to maximize the tradeoff between performance and power consumption, spindle motor speed is varied using control signals of the processor 12 provided to the spindle motor driver 18.

Control of spindle motor speed to a desired level is described with respect to FIG. 6, which shows details of the components of the spindle motor driver 18 and spindle motor 30. The spindle motor 30 includes a coil 62 with three windings 63, 64 and 65 electrically arranged in a Y configuration. A rotor 68 of the spindle motor 30 has magnets that provide a permanent magnetic field. The spindle motor driver circuit 18 supplies current to windings 63-65 to cause rotor 68 to rotate at a desired operating spin-rate. The spindle motor driver 18 includes a commutation and current application circuit 50 to apply different commutation state currents across windings 63-65 at different times. The commutation circuit 50 may monitor the time period between back emf zero crossings using the spindle motor back emf detector 52 and use this time period information to enable determination of the speed of spindle motor 30. The speed indication is then used by the commutation circuit 50 to control the commutation voltages applied across windings 63-65 to accomplish a desired speed as indicated from code received from processor 12. During open-loop startup, commutation states are determined internally or provided from the processor 12 without need for the back-emf measurement.

Although the commutation circuit 50 may perform processing to calculate necessary winding currents, in an alternative configuration such processing is performed by the processor 12. Further, such calculations may be performed by the processor using servo address markers (SAM) read from the servo data on disk 2 instead of back-emf signals. The SAMs occur in the servo data received by the processor 12, and like the rest of the servo data the SAMs occur periodically enabling the processor 12 to determine the rate of speed the spindle motor 30 is operating. Once calculations are made, control signals are provided from processor 12 to the commutation circuit 50 to apply appropriate currents to maintain a desired speed. Alternatively, the spin speed determined by the processor 12 from the SAMs is sent to the commutation circuit 50 which processes the information and sets currents to apply to assure the spindle motor 30 is operating at a desired speed.

In one embodiment, should access to the disk drive not be requested for a predetermined time, the spindle motor is spun down to conserve power and to maximize the life of the spindle motor. As indicated above, for open-loop start up conditions, spindle motor speed control is typically based on codes applied from the processor 12 to the commutation circuit 50 to cause currents to be applied to bring the spindle motor from a stopped position to a desired operation speed. Current can then be withdrawn to cause spin-down of the motor.

Because read and write operations are affected by spindle motor speed, the clock for the read/write channel 16 is set depending on the spindle motor speed. To set the clock speed of the R/W channel 16, clock controller 32 is used to apply different clock signals in relation to the speed set for the spindle motor.

b. VCM Speed

Signals are further provided from the power management controller 34 to the processor to control speed of the VCM during a track seek operation. The processor 12 is further shown in FIG. 1 providing signals to the VCM driver 10. In disk drives of mobile devices, the speed of actuator movement during a track seek operation is typically set somewhat lower than in stationary devices, which do not use battery power. Track seek operations are initiated when the transducer 4 must be moved from its current track to a different track on the disk. In accordance with the present invention, to optimize the tradeoff between performance and power consumption, VCM speed is varied using control signals from the processor 12 provided to the VCM 10.

Control of VCM motor speed to a desired level is described with respect to FIG. 7, which shows details of the VCM driver 10 of FIG. 1 as connected to the VCM 7. As shown, the VCM driver 10 includes a VCM current application circuit 80, which applies current to the coil 95 of the VCM 7 with a duration and magnitude controlled based on a signal received from the VCM driver 10. The coil 95 is modeled in FIG. 7 to include a coil inductance 91, a coil resistance 92 and a back emf voltage generator 93. Current provided through the coil 91 controls movement of the rotor 94, and likewise movement of the rotor generates a back emf voltage in voltage generator 93.

The VCM driver 10 further includes a back emf detection circuit 82 for sensing the velocity of the actuator based on an estimate of the open-circuit voltage of the VCM 7. The open-circuit voltage of the VCM is estimated by observation of the actual VCM voltage and the VCM current (either the commanded current or the sensed current, sensed using a series resistor 90), and multiplication of the current by an estimated VCM coil resistance and subtraction of that amount from the measured coil voltage. As indicated previously, during shut down, the actuator 6 is positioned on a ramp 28 situated off to the side of a disk 2 to prevent contact between the transducer head 4 and disk 2. During startup, actuator velocity down the ramp 28 is controlled using measurements from the VCM back emf detection circuit 82 so that the slider of transducer 4 encounters the disk 2 while moving down the ramp 28 in a controlled manner.

The seek command requires the actuator to move the head from the current track to a different track, and requires some time for the processor to generate, in part because the processor 12 typically has to generate an appropriate destination from the transfer data command. This can result in a code bottleneck between the receipt of a transfer data command and start of the seek command.

In a further embodiment of the present invention, power consumption levels of components are maximized when the components are performing more critical operations, and power is then reduced when less critical operations are performed. For instance, when servo control signals are being processed by the processor to compute a control signal to be applied to the VCM driver, processor clock speed and system voltage are set to a higher level than at other times. Further, the processor clock speed is increased in a bottleneck period between when the disk drive processor receives a command to transfer data, and when the processor starts the execution of a seek command. Clock speed may further be increased after receipt of a read or write command from the ATA bus until the command is executed to improve interfacing performance of the drive.

Although the present invention has been described above with particularity, this was merely to teach one of ordinary skill in the art how to make and use the invention. For example although the present invention is described for use with hard disk drives for recording in magnetic media, it is understood that principles in accordance with the present invention can be used with optical disk drives. Many additional modifications will fall within the scope of the invention, as that scope is defined by the following claims.

1. A disk drive system comprising:
a processor configured to control power consumption between different levels depending on a type of the code being executed.

2. The disk drive of claim 1, wherein code executed when the highest one of the power consumption levels is active is servo code.

3. The disk drive of claim 1, wherein code executed when the high one of the power consumption levels is active is a track seek operation.

4. The disk drive of claim 1, wherein the different levels comprise at least three different power levels.

5. The disk drive of claim 4, wherein the different levels comprise first and second levels wherein different spindle motor speeds are provided, and a third level wherein the spindle motor is spun down.

6. The disk drive of claim 4, wherin a high power level is provided when a predetermined operation performed by the processor includes reading or writing through an external interface bus.

7. A disk drive system comprising:
a spindle motor having a shaft supporting a rotatable disk;
an actuator that supports a transducer;
an interface to an attached or enclosing system; and
a processor coupled to receive servo data read from the rotatable disk by the transducer, and to provide servo code signals indicating actuator movement should occur in response, and coupled to the spindle motor to control rotation speed of the rotatable disk, and coupled to the interface to receive operation instructions, wherein the processor is configured to provide instructions to control power consumption between at least two power levels for at least two of the actuator, spindle motor, user interface and processor during operations performed by the disk drive.

8. The disk drive system of claim 7 further comprising:
a memory storing data which can be read by the processor, the data including code for causing the processor to select between the two power levels, wherein a first power level is caused to be selected when improved performance is desired, and wherein a second power level less than the first is selected when minimum power consumption is desired.

9. The disk drive system of claim 8, wherein the memory is a random access memory.

10. A method of operating a disk drive system comprising controlling power consumption between at two different power levels depending on a type of code being processed.

11. The method of claim 10, wherein a highest one of the power consumption levels comprises when servo code is being processed.

12. The method of claim 10, wherein a high one of the power consumption levels comprises code for performing a track seek operation.

13. The disk drive of claim 10, wherein power consumption is controlled between at least three different power levels.

14. A method of stepping power levels in a system with a hard disk drive comprising:
interpreting power command signals from an interface bus;
selecting a nominal power mode that would spin at a nominal speed, seek at a nominal speed, use a standard core voltage, run a read/write channel at the nominal rate, and use a standard servo coefficients based on a first one of the command signals;
selecting a high power mode that would do at least one of: spinning faster, providing faster seeks, using a higher core voltage, running the read/write channel at a higher frequency than the normal power mode, and/or switching to using a high power set of servo coefficients, based on a second one of the command signals; and
selecting a low power mode that would do at least one of: spinning at a reduced speed, seeking slower, using a lower core voltage, running the read/write channel at a lower frequency than in the normal mode, and/or switching to a low power set of servo coefficients, based on a third one of the command signals.

15. The method of claim 14, wherein the command signals are provided from at least one of an external user interface, and signals generated internal to a system housing the hard disk drive.
